(19) United States
(12) Patent Application Publication
(10) Pub. No.: US 2004/0155608 A1
(43) Pub. Date: Aug. 12, 2004

(54) Device for controlling a lamp including at least two LEDs emitting light in different colors

(76) Inventors: Robert Trinschek, Hamm (DE); Ralf Rehbein, Hamm (DE); Siegfried Schmees, Geseke (DE); Frank Gronemeier, Boenen (DE); Carsten Geske, Oelde (DE); Bernhard Mueller, Arnsberg (DE); Thomas J. Meyer, Pinellas Park, FL (US)

Correspondence Address: BIRCH STEWART KOLASCH & BIRCH, PO BOX 747, FALLS CHURCH, VA, 22040-0747, US

(21) Appl. No.: 10/771,228

(22) Filed: Feb. 4, 2004

Related U.S. Application Data
(60) Provisional application No. 60/444,680, filed on Feb. 4, 2003.

(51) Int. Cl. H05B 37/02

(52) U.S. Cl. 315/291; 315/224

(57) ABSTRACT

The device (10) for controlling a lamp including LEDs emitting light in at least two different colors comprises at least two current sources (14,16,18) of which each is assigned to a group of LEDs (20,24,26) emitting light of the same colors; and is arranged to supply these LEDs (20,24,26) with a continuous current having an adjustable amplitude. Further, the device (10) comprises a control unit (30) for controlling the current sources (14,16,18) to adjust the amplitudes of the currents generated by the current sources (14,16,18) so as to generate a desired color of the mixed light emitted by the totality of the LEDs (20,24,26), and a setting unit (36) for influencing the total current of all current sources (14,16,18) to thus set the intensity of the mixed light.

### BACKGROUND OF THE INVENTION

1. Field of the Invention

The invention relates to a device for controlling a lamp including at least two LEDs emitting light in different colors. Preferably, the lamp to be controlled by the inventive device is provided with three groups of LEDs wherein the LEDs of each group emit light in one of the three basic colors (red, green, blue).

2. Description of Related Art

Due to their functional reliability and their longevity, light emitting diodes (LEDs) are increasingly used in the field of general lighting (households, ambient lighting, courtesy lights and outside lights in automobiles). LEDs, however, particularly LEDs emitting white light, are relatively expensive. Compared to these, LEDs which emit light in only one (basic) color are more moderately prized.

It is known that light of any color can be generated by mixing red, green and blue LED light. Thus, it is possible, for instance, to generate white light by use of a red, a green and a blue LED. Also light of every other color can be generated by such a lamp. In doing so, the mixing of basic colors for generating a desired mixed color is performed by setting the intensities of the individual basic colors. Advantageously, each lamp is provided with at least two groups of LEDs of which one group emits red light, a second group emits green light and a third group emits blue light.

Normally, for controlling an LED, use is made of a constant current source wherein the amplitude of the constant current is adjustable. To generate mixed light of a desired color, it is further known from WO-99/10867 to use pulse width modulation for setting the current in LEDs emitting light in different colors.

Known from JP-A-07035787 and Patent Abstracts of Japan, Vol. 1995, No. 05, Jun. 30, 1995, is an LED unit wherein, by specification of input voltages through comparators, the accompanying amplitude will effect, through selection of the LEDs to be switched on, a change of colors on the basis of analog technology. A dimming of the mixed light, i.e. an adjustment of the intensity of the mixed light, is not possible in this known circuit concept.

It is an object of the invention to make it possible that the color and the intensity of the mixed light generated by the superposition of differently colored light of LEDs can be set in a simple manner and within a wide range.

### SUMMARY OF THE INVENTION

To achieve the above object, there is proposed, according to the invention, a device for controlling a lamp including LEDs emitting light in at least two different colors, said device comprising

at least two current sources of which each is assigned to a group of LEDs emitting light of the same color and is arranged to supply these LEDs with a continuous current having an adjustable amplitude,

a control unit provided for controlling the current sources to adjust the amplitudes of the currents generated by the current sources so as to generate a desired color of the mixed light emitted by the totality of the LEDs, and

a setting unit for influencing the total current of all current sources to thus set the intensity of the mixed light.

According to the invention, the individual control of the intensity of the LED of a color is performed by setting the amplitude of the current flowing through this LED. A pulse width modulation is not provided according to the invention.

Assigned to each group of LEDs (wherein the LEDs within a given group will emit light of the same color) is a current source whose constant current can be set in dependence on the amplitude. The total current, i.e. the sum of the individual currents to be generated by the current sources, is influenced by a setting unit so that the intensity of the mixed light can be set. Thus, depending on the desired intensity of the mixed light, this setting unit will subject each individual current to the same change in terms of percentage. In this manner, it will not be the color of the mixed light but only its intensity which is changed.

The inventive device is advantageous in that the dimming function is simplified. This is the case because dimming is effected by use of the total current, i.e. each individual current will undergo the same change in terms of percentage. Under the technical aspect, this can be realized in a quite simple and reliable manner.

The lamp to be controlled by the inventive device preferably comprises a plurality of LEDs each emitting light of one color. In such an arrangement, the LED of each color are connected in series. A plurality of such serial connections can be arranged in parallel to each other. The inventive device is provided with an output connector having the total current flowing there-through and being adapted to have all serial connections of LEDs connected thereto on one of their ends. The other ends of the serial connections are connected to different outputs of the inventive device. These different out-puts are connected, within the device, to the current sources assigned to the individual color LED.

A first variant for setting the overall current resides in the influencing of the amplitude of the total current. Alternatively and preferably, however, the setting unit for influencing the total current is a modulation unit for pulse width modulation of the total current so as to set the intensity of the mixed light. Thus, in this variant, the LEDs have a direct current discontinuously flowing therethrough merely for the purpose of dimming the mixed light. A setting of colors by means of pulse width modulation of the total current is not possible.

In a second variant of the invention, the LEDs are operated by use of linear current sources controlled by linear voltage controllers which in turn are controlled by PWM signals. For each color, a circuit arrangement of this type is provided. For operating the individual color LEDs, three of these circuit constellations will then be connected in parallel, wherein the sum of all of the individual currents can be dimmed by the individual color LEDs, which is likewise performed by a PWM signal.

By the combination of (1) the setting of the mixed color by analog setting of the currents through their amplitude and (2) the dimming of the intensity of the mixed light by a PWM signal, it is not necessary anymore to consider different color characteristics of the LEDs since the pulse-pause ratio has the same effect for all of the LEDs.

The advantage of the pulse width modulation over the amplitude control for influencing the intensity of the mixed light is to be seen in the simplified technical realization.

### BRIEF DESCRIPTION OF THE DRAWING

Two embodiments of the invention will be explained in greater detail here-under with reference to the drawing. The individual Figures illustrate the following:

FIG. 1 a block diagram of the first variant of the control unit according to the invention,

FIG. 2 a block diagram of the second variant of the control unit according to the invention, and

FIG. 3 a block diagram of the third variant of the control unit according to the invention.

### DETAILED DESCRIPTION OF PREFERRED EMBODIMENTS OF THE INVENTION

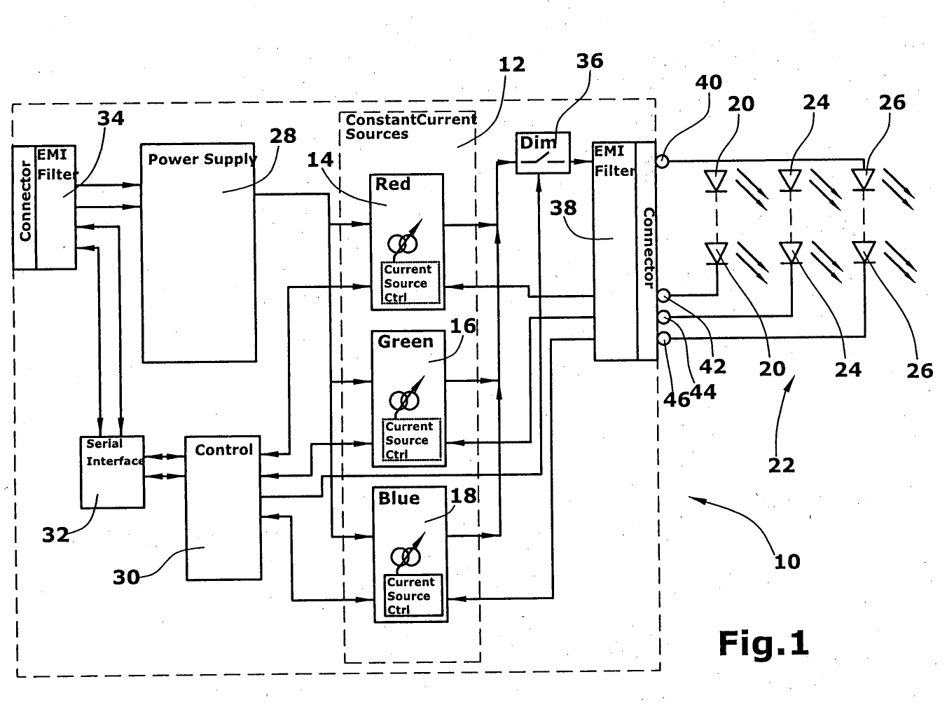

According to FIG. 1, the first variant of the control device 10 of the invention comprises a constant current supply unit 12 including three current sources 14,16,18. By means of the first current source 14, a constant current is generated to flow through the red LEDs 20 of a lamp schematically indicated at 22 while the second current source 16 and the third current source 18 are provided to generate constant current flowing through the green LEDs 24 and the blue LEDs 26, respectively, of the lamp 22. The energy supply of the three current sources 14-18 is performed by an energy supply unit 28 while the setting of the amplitude of the constant direct currents of the three current sources 14-18 is performed through a control unit 30. An interface 32 is used for coupling to a data bus (not shown), with an EMI filter 34 connected between the interface 32 and the data bus.

The individual currents emitted by the three current sources are added. The overall current passes through a setting unit 36 and an EMI filter 38 connected downstream thereof.

As shown in FIG. 1, the LEDs 20,24,26 of the individual colors are connected in series relative to each other. The serial connections have their one ends electrically connected to each other and to the output 40 of device 10 which supplies the overall current. The other ends of the serial connections are connected to respectively different outputs 42,44,46 of device 10 which are internally connected to respectively one of the three current sources 14-18.

In this embodiment, the setting unit 36 is a modulation unit for pulse width modulation of the total current. The controlling of this modulation unit for influencing the intensity of the mixed light of the LEDs 20-26 and thus the controlling of the intensity are performed by means of the control unit 30, as is the case for the controlling of the current sources 14-18 through which the color of the mixed light is settable.

Using the above described control device 10, the color and the intensity of the mixed light can set. In the process, the colors, i.e. the intensities of the individual light sources relative to each other, are not controlled by a pulsating direct current flowing through the individual LED but instead by setting the amplitudes of the individual currents flowing through the groups of same-colored LEDs. The setting of the overall brightness of the mixed light (dimming) is accomplished by switching the total current on and off, i.e. by pulse width modulation.

The advantage of setting the color by setting the amplitudes of the constant currents, as compared to pulse width modulation which basically would also be useful for this purpose, shall be briefly clarified hereunder. If pulse width modulation is used for the setting of colors and for the dimming alike, the resolution of the individual dimming stages is limited. When setting e.g. a color having a blue portion of 20%, the PWM signal in pulse width modulation for color setting is set to an on-time of 20% and an off-time of 80%. Since in a PWM signal the width of the individual steps is fixed (smallest resolution), then, with a pulse width of 20%, only relatively few steps will remain for the dimming of the total brightness until the blue portion is finally switched off completely. In other words, the extent of the dimming is considerably restricted.

In the inventive combined application of a constant current with different amplitude per color and a common pulse width modulation, however, the triggering of the dimming will always be constant. Again assuming an example wherein a color is set whose blue portion is 20%, the amplitude of the current passing through the blue LEDs is reduced to 20%. The current nonetheless still has a “pulse width” of 100% since the constant current is an analog signal. If the overall brightness is to be reduced (dimming), one can decrease the “pulse width” of the signal with the amplitude of 20% from 100% to 0% over the whole width. Thus, all steps will be disposable for dimming.

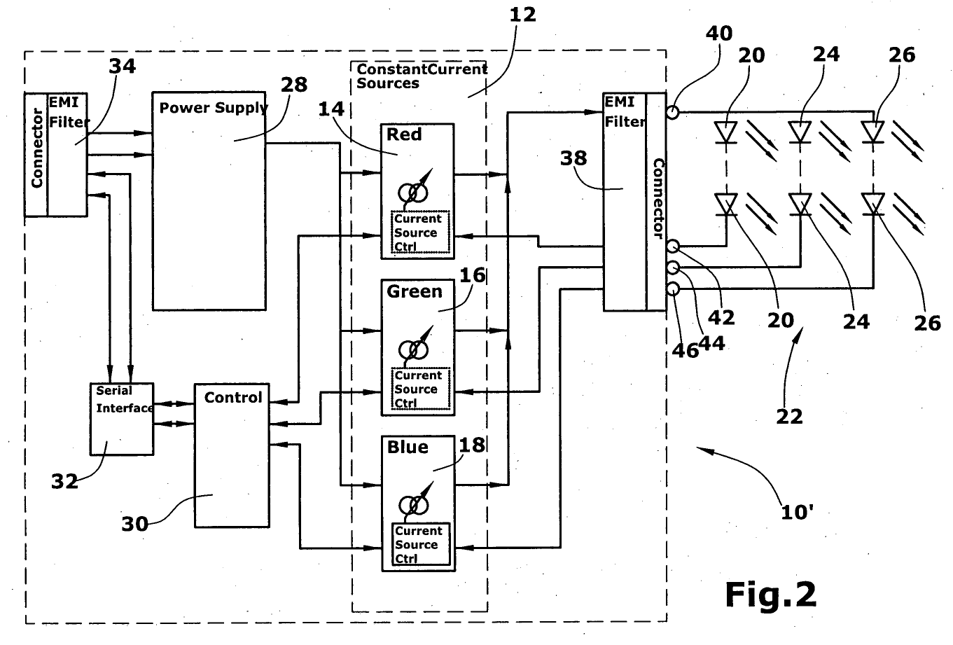

An alternative embodiment of a control device 10′ is shown in FIG. 2. As far as the components in FIG. 2 correspond to those in FIG. 1, they are provided the same reference numerals.

Except for the setting unit for the intensity of the mixed light, both variants of the control device 10 and 10′ are identical in function. In the control device 10′ according to FIG. 2, dimming is performed by setting the amplitude of the individual constant currents, which is carried out by control unit 30. The influencing of the individual constant currents for setting the intensity of the mixed light is performed with identical percentage for all individual constant currents whereby the ratios of the amplitudes of the individual constant currents relative to each other do not change so that the color of the mixed light will be identical.

By way of alternative to the above described setting of the intensity of the mixed light according to FIG. 2, it would also be possible, prior to impressing the total current into the lamp 22, to split off partial current from the total current, which partial currents would be led back to the current sources 14-18. Such a circuit concept, however, will result in a higher power loss portion and thus a reduced efficiency.

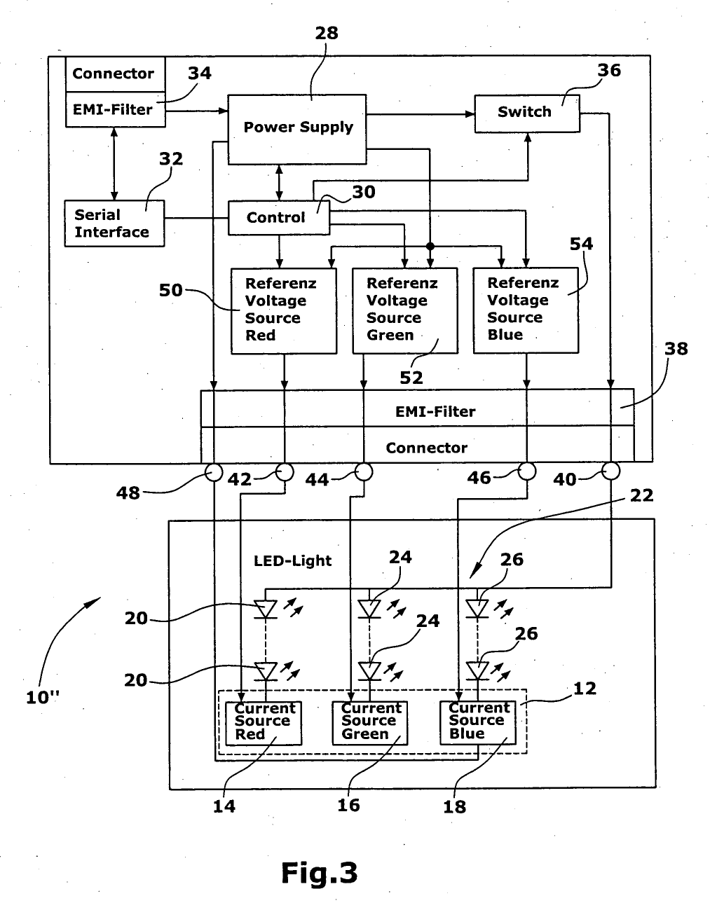

FIG. 3 shows a third variant of the inventive circuit concept of a control unit 10″. Also in this control unit 10″, those components which correspond to the components of control units 10 and 10′ bear the same reference numerals. Different from the two above described variants, the controlling of the constant current sources 14,16,18 for the various color LEDs is carried out through linear voltage controllers 50,52,54 which are controlled by control unit 30 through PWM signals. The linear voltage controllers 50,52,54 in turn control the linear current sources 14,16,18. Since these current source are integrated into the lamp module 22 (which is however not essential to this variant of the invention because these current sources can generally also be arranged externally of the lamp), the module is connected to the rest of the control device 10″ not only via the connections 40-46 but also via a further connection 48. The setting unit 36 can be used for setting the total current flowing through all LEDs, thus effecting a dimming of the mixed light. Thus, while the mixed color is realized by corresponding control of the voltage controllers 50,52,54 which in turn control the current sources 14,16,18, dimming is performed by use of the setting unit 36 which is likewise controlled by control unit 30.

Thus, also the circuit variant according to FIG. 3 is adapted to set the color and brightness of an LED color application. In doing so, the color setting is generated not through a PWN signal but by means of linear control so that the changing of the brightness, which is again performed through a PWM signal, can be accomplished with full resolution (e.g. 255 steps in case of 8 Bits). For this purpose, each group of same-colored LEDs is provided with a linear constant current source. All of the linear constant current sources are

1. A device for controlling a lamp including LEDs emitting light in at least two different colors, said device comprising
at least two current sources (14,16,18) of which each is assigned to a group of LEDs (20,24,26) emitting light of the same color, and is arranged to supply these LEDs (20,24,26) with a continuous current having an adjustable amplitude,
a control unit (30) provided for controlling the current sources (14,16,18) to adjust the amplitudes of the currents generated by the current sources (14,16,18) so as to generate a desired color of the mixed light emitted by the totality of the LEDs (20,24,26), and
a setting unit (36) for influencing the total current of all current sources (14,16,18) to thus set the intensity of the mixed light.

2. The device according to claim 1 wherein the amplitude of the total current is adjustable by the setting unit (36).

3. The device according to claim 1 wherein the setting unit (36) is arranged as a modulation unit for pulse width modulation of the total current for setting the intensity of the mixed light.

4. The device according to claim 1 wherein at least three current sources (14,16,18) are provided which generate current for LEDs emitting light in the three basic colors.
